(19) United States
(12) Patent Application Publication
(10) Pub. No.: US 2006/0279015 A1
(43) Pub. Date: Dec. 14, 2006

(54) Stereo in mold transfer printing method of silicone

(76) Inventor: Ching-Shing Wang, Taichung City (TW)

Correspondence Address: BACON & THOMAS, PLLC, 625 SLATERS LANE, FOURTH FLOOR, ALEXANDRIA, VA, 22314, US

(21) Appl. No.: 11/150,158

(22) Filed: Jun. 13, 2005

(51) Int. Cl. B29C 45/14

(52) U.S. Cl. 264/132; 264/259

(57) ABSTRACT

Disclosed is a stereo transfer printing method of in mold transfer printing concurs with injection molding of silicone. The stereo in mold transfer printing method of silicone includes the following steps: (a) providing ink mixed with silicone; (b) using the silicone containing ink to print text or graphic needed on the substrate film; (c) positioning the text or graphic on the substrate film between the mold dies; (d) closing and locking the mold; (e) injecting the silicone; and (f) opening the mold and getting the silicone product.

### BACKGROUND OF THE INVENTION

1. Field of the Invention

The present invention relates to a stereo transfer printing method, and in particular to a stereo transfer printing method of in mold transfer printing concurs with injection molding of silicone.

2. The Prior Arts

If it is desired to form text or graphic on the surface of general product of plastic material except the color thereof, people usually print ink on the surface of the product by printing. However, it will be difficult to print because of the surface of the product is not always plain, and on the other hand, the adhesion of the ink is not good and will be decolorieed easily by rub because of the ink is sticking to the formed product, and the surface of plastic having features of gloss, it is not an ideal method to print color.

To improve the disadvantages above mentioned, then it is developed a coloring method in injection mold when transfer printing called in mold decoration, IMD. The general steps of IMD comprise: (a) printing on film, to print the text or graphic needed for printing on a substrate film; (b) three-dimensional high pressure forming, use high pressure air to impress the substrate film and make the three dimensional formation of mold core; (c) die cutting to trim film, to trim the surplus three-dimensional forming substrate film by stamping equipment; and (d) injection molding, after the three-dimensional substrate film was put into the mold then proceed injection molding. The substrate film will blend and adhere to the surface of the formed product with ink together by this way, so it is also called in mold labeling injection. Another quite similar process is called in mold transfer printing injection, in which the substrate film can be separated from the formed product after the adhesion of the ink.

However, the defective fraction of the current fabrication method of IMD is quite high. The reason is that the quality of the ink printed on the substrate film will become unstable after secondary fabrications (including high pressure forming, die cutting and injection molding). The melting point temperature of ink is 135° C., but the general injection plastic material is fabricated at temperature between 160-280° C., so when the ink contact with the plastic material of high temperature then the ink will dissolve and occur ink shifting to make the text or graphic printed looks like fizzy. Besides, since the ink become fragile after printing and drying, the ink at the bending often crash and lead to light penetrating at the site by the strong bending of the substrate film when high pressure forming and die cutting. Even though all the drawbacks above mentioned could be improved, the improvement of the adhesion after the ink in mold transfer printing onto the surface of the plastic will be limited and the ink will still be decolorized easily after used.

On the other hand, the substrate film printed with text or graphic has to go through high pressure forming and die cutting during the process of transfer printing, and then put the substrate film into mold to proceeding injection molding. It is very inconvenient of adding steps of the process and will increase the manufacture cost largely to additionally set up the mold coordinate with the high pressure forming and die cutting. The IMD of plastic is well known for years, but the automation injection molding of silicone is another important development area in recent years especially of its particular quality have quite good effects in several commercial applications. But, for all the conventional silicone injection molding product, if it is desired to put text or graphic on the product, then it is to do printing or transfer printing on the formed product The results will be the same as described above that it is quite difficult to print on the surface that is not plain; and on the other hand, since the ink is adhered to the product already formed and the adhesion is not good, it will be decolonized easily by rub, and the color saturation of transfer printed product is not enough also because of the bad adhesion, and the outline of text or graphic is more unclear.

### SUMMARY OF THE INVENTION

The present invention is aimed to provide an stereo in mold transfer printing method taking advantage of in mold decoration manner to proceed ink transfer printing by silicone containing ink concurs with silicone injection molding, which in order to improve the adhesion of ink with formed silicone above mentioned, to improve the complicated steps of transfer printing at the same time, and to reduce the equipment cost needed for process. By means of silicone containing ink above mentioned to blend with the silicone when injection molding to largely increase the adhesion of ink with silicone to prevent the ink from shedding and have better saturation of color and clearer outline at the same time. On the other hand, to simplify the steps of injection molding and in mold transfer printing coordinate with the designation of mold and transfer printing apparatus to increase the efficiency of production, and to reduce the equipment cost needed for production.

The stereo in mold transfer printing method of the present invention comprises steps: (a) providing ink mixed with silicone; (b) using the silicone containing ink to print text or graphic needed on the substrate film; (c) positioning the text or graphic on the substrate film between the mold dies; (d) closing and locking the mold; (e) injecting the silicone; and (f) opening the mold and getting the silicone product The substrate film is rolled by two rollers to continuously carry out the transfer printing of next text or graphic after the transfer printing of a text or graphic.

By means of the present invention, the transfer printing substrate will be clamped in the molding space formed between the two mold dies after closing and locking the two mold dies, and then directly proceed injection molding in the following steps. The solid or liquid silicone material could be used to inject the silicone material into the mold by feeding nozzle when injection molding. Then to heat the silicone material in the mold by the heating equipment connected to the first and second mold die, which is to switch the process of heating the injection material in the injection apparatus originally into process in the mold for gradually blending of ink with injection material during the process of heating to increase the adhesion of ink with silicone and make the ink more difficult to be decolorized Since the silicone transfer printing equipment of the present invention omit the steps and equipments of high pressure forming and die cutting to trim film, it saves a lot of cost on the process of injection molding and transfer printing, and improves largely the production capacity.

Most important of all, the silicone containing ink has similar character with the molding silicone, so these two can blend with each other to have the best adhesion during the process of high pressure heating molding and transfer printing, and prevent the ink from being decolorized in the future, and further make the color of transfer printing more saturated and colorful simultaneously because of the strong adhesion of the ink. At the same time, also because these two have similar characters, it can improve the conventional ink shifting made by the difference of melting point to make the text or graphic of transfer printing clearer.

The embodiment of the present invention is further explained in the following embodiment examples and more detailed description. It is to be understood that the following detailed description are exemplary and explanatory which are intended to provide further explanation of the invention as claimed. The present invention disclosed above is not limited by these examples. The present invention may be altered or modified a bit and all such variations are within the scope and spirit of the present invention.

### BRIEF DESCRIPTION OF THE DRAWINGS

FIG. 1 is a schematic view showing an embodiment of the present invention;

FIG. 2 is an explanation view showing an embodiment of the present invention;

FIG. 3 is an explanation view showing an embodiment of the present invention after locking the mold;

FIG. 4 is an explanation view showing injection molding concurring with transfer printing according to an embodiment of the present invention; and

FIG. 5 is a schematic view showing injection molding silicone product according an embodiment of the present invention.

### DETAILED DESCRIPTION OF THE PREFERRED EMBODIMENT

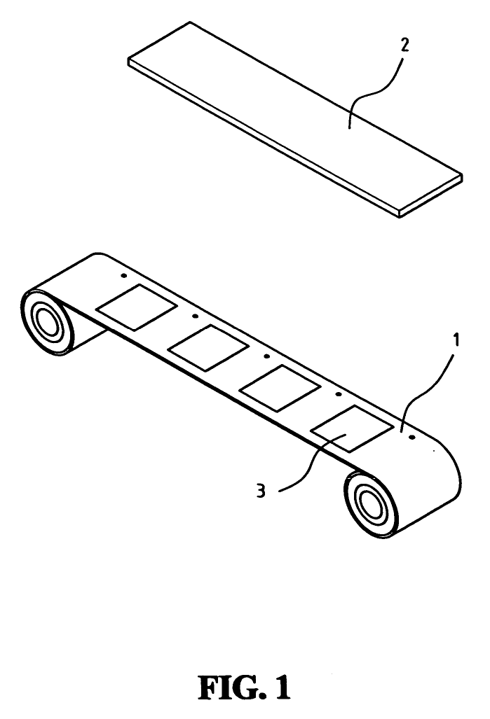

With reference to the FIG. 1, which is a schematic view showing an embodiment of the present invention, a stereo in mold transfer printing method of silicone in accordance with the present invention firstly mixes coloring material for printing with silicone to make a silicone containing ink, and then makes the ink printed on a substrate film 1 through screen 2 according to need with text or graphic by different colors and distribute the transfer printing ink 3 of text or graphic to be transfer printed on the substrate film 1. The substrate film generally used for transfer printing could be the polyester film or polypropylene film, which may comprise polyethylene terephthalate (PET), oriented polypropylene film (OPP) or other films of similar character.

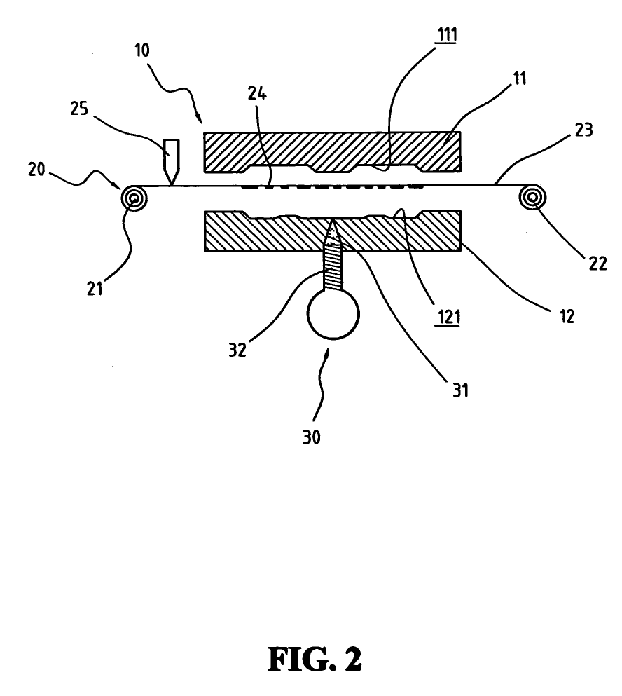

With reference to the FIG. 2, which is an explanation view showing an embodiment of the present invention, the equipment used for the stereo in mold transfer printing method of silicone in accordance with the present invention comprises a mold clamping apparatus 10, a transfer printing apparatus 20 and an injection apparatus 30.

Also referring to the FIG. 2, the mold clamping apparatus 10 comprises a first mold die 11, a second mold die 12 and a component (not shown) connected to the first mold die 11 and the second mold die 12 simultaneously for opening and closing the mold. The first mold die 11 is constructed with a first mold shape 111 which is the stereo formation of text or graphic to be presented, and the second mold shape 121 constructed in the second mold die 12 is the main structure of injection product which could be the keypad or shell of electronic equipment like cell phone or calculator, or the covering sheath of commodity like racket, and even more the bottom of shoe. The text, graphic or trade mark which is transfer printed on the main structure have great effects of prominence for the aestheticism, quality and the brand recognition, and it will be high value product of potential in the future.

The transfer printing apparatus 20 comprises a first roller 21 and a second roller 22 which are set on the lateral side of the first mold die 11 and the second mold die 12 to make the transfer printing substrate 23 rolled by the two roller could be set between the first mold die 11 and the second mold die 12. The first roller 21 and the second roller 22 could roll the transfer printing substrate 23 which printed with text or graphic for transfer printing to continuously roll in the transfer printing substrate 23 during the process to continuously proceed with injection and transfer printing. The transfer printing apparatus 20 could further be connected to a position equipment 25 of the transfer printing substrate 23 to make the text or graphic printed exactly correspond to the figure of the mold die when the transfer printing substrate 23 rolled by the roller after each transfer printing, and to make the ink to be adhered to the correct position for transfer printing next. The position equipment 25 could be a X-Y axis position system, an image scanning position system or other systems which could be used to position. The transfer printing ink 24 printed on the transfer printing substrate 23 is faced to the second mold die 12.

The injection apparatus 30 is connected to the second mold die 12 and passes through the second mold die 12 by a feeding nozzle 31 and connects through the molding space 40 formed between the first mold die 11 and the second mold die 12.

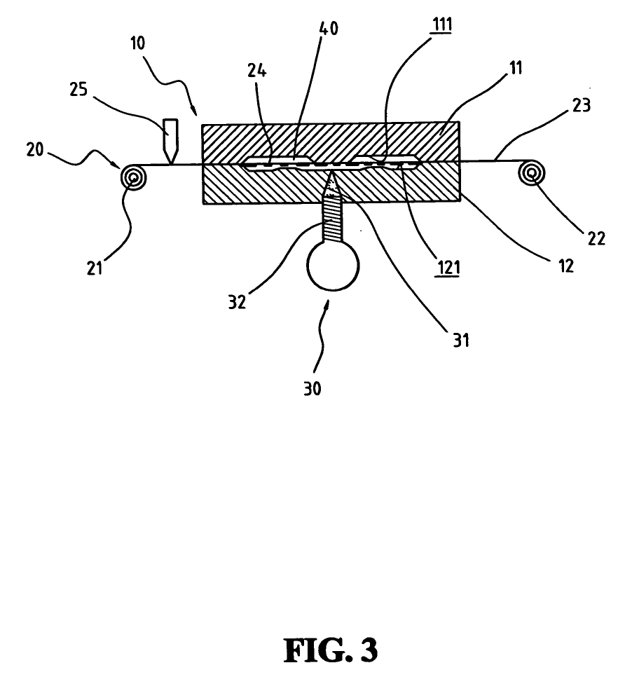

With reference to the FIG. 3, which is an explanation view showing an embodiment of the present invention after locking the mold. After the transfer printing substrate 23 is rolled by the rollers 21, 22 and positioned by the position equipment 25, it is corresponding to the mold figure to be transfer printed, and now it is ready to proceed the action of closing mold to clamp the first mold die 11 and the second mold die 12 by a component connected to the first mold die 11 and the second mold die 12 simultaneously for opening and closing the mold. The transfer printing substrate 23 after clamping is set and hanged in the molding space 40 formed between the first mold die 11 and the second mold die 12.

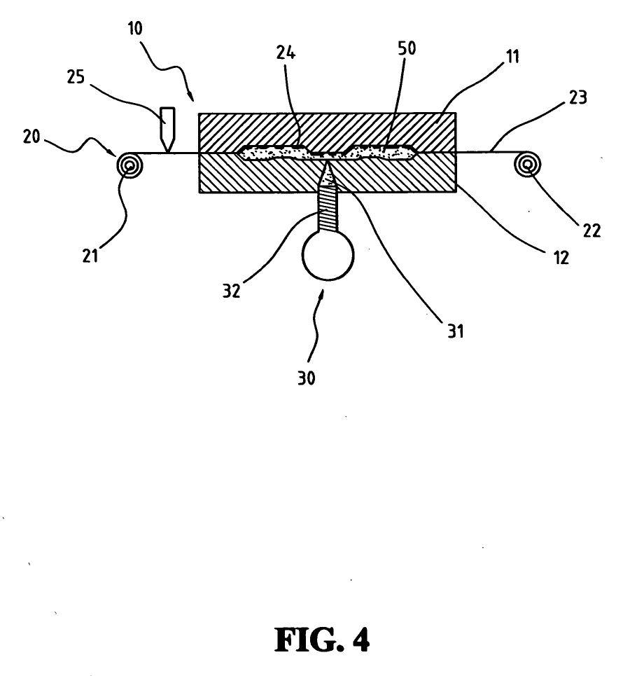

With reference to the FIG. 4, which is an explanation view showing injection molding concurring with transfer printing according to an embodiment of the present invention. After closing and locking the mold, it is ready to proceed injection molding. When injection molding, the solid or liquid silicone material could be injected into the mold by the feeding nozzle 31 through the feeding rod 32, and it is so called cold material injection process. After that, then to heat the silicone injection material in the mold by a heating equipment (not shown) which is connected to the first mold die 11 and the second mold die 12 to make the silicone molding concurring with transfer printing to increase the adhesion of the ink with the silicone.

During the injection molding of silicone, the silicone material will make the transfer printing substrate 23 spreading out to the first mold shape 111 after injection, and further form the construct of the first mold shape 111, so the steps of conventional high pressure forming and die cutting to trim film is not needed, and it could reduce largely the process cost To avoid the transfer printing substrate 23 to be damaged during spreading out, the depth of the first mold die 11 have to be designed according to the spreadability of the transfer printing substrate 23 to design the height of the construct under the limitation of capable spreading.

Besides, during the process of the injection molding, since the ink contains silicone, the ink has more similar character with the molding silicone and the ink will be able to adhere to the molding silicone closely during the process of molding and transfer printing, and the ink will blend with the molding silicone to prevent from shedding. Also because of the enhancing adhesion of the ink and blending with the molding silicone simultaneously, it further make the color of the transfer printing more saturated and improve the shifting of the ink at the same time to make the text or graphics clearer.

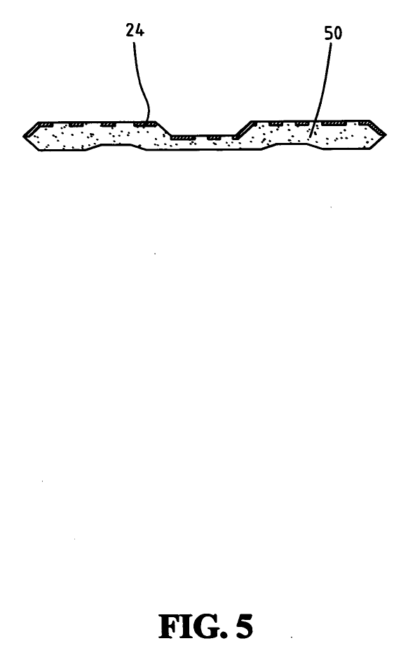

After completing the process of the injection molding, the construct of the silicone product 50 has been fixed after cooling, and the transfer printing ink 24 has also been transfer printed and blended to the surface of the silicone product 50 (with reference to the FIG. 5). At this time, use the component for opening and closing mold which is above mentioned to open the first mold die 11 and the second mold die 12 to get the silicone product 50, and then roll the first roller 21 and the second roller 22 to position another transfer printing text or graphic between the mold dies to proceed next cycle of injection transfer printing steps so as to proceed steps of continuous injection transfer printing.

What is claimed is:

1. A stereo in mold transfer printing method of silicone, comprising steps:
(a) providing ink mixed with silicone;
(b) using the silicone containing ink to print text or graphic needed on the substrate film;
(c) positioning the text or graphic on the substrate film between the mold dies;
(d) closing and locking the mold;
(e) injecting the silicone; and
(f) opening the mold and getting the silicone product

2. The method as claimed in claim 1, wherein the substrate film is rolled by two rollers to continuously proceed with the transfer printing of next text or graphic after the transfer printing of a text or graphic.

3. The method as claimed in claim 1, wherein the mold dies further comprise a heating equipment.

4. The method as claimed in claim 3, wherein step (e) is to process heating after feeding the mold die with solid silicone.

5. The method as claimed in claim 3, wherein step (e) is to process heating after feeding the mold die with liquid silicone.
